(19) United States
(12) Patent Application Publication
(10) Pub. No.: US 2012/0318114 A1
(43) Pub. Date: Dec. 20, 2012

(54) CUTTING DEVICE FOR SUGAR CANE HARVESTER

(76) Inventor: Iñaki ESAIN EUGUI, Legazpia (Guipuzcoa) (ES)

(21) Appl. No.: 13/490,535

(22) Filed: Jun. 7, 2012

Related U.S. Application Data
(63) Continuation of application No. PCT/ES2010/070817, filed on Dec. 10, 2010.

(30) Foreign Application Priority Data
Dec. 11, 2009 (ES) U200930741

(51) Int. Cl. B26D 1/00

(52) U.S. Cl. 83/651

(57) ABSTRACT

The present invention relates to a cutting device for sugar cane harvesters that includes support discs, where several radial blades through fixing bolts are fixed, and that is characterized in that the radial blades (3) have through-slots (6) comprising a larger section allowing the passage of the head of the fixing bolts (4) and at least one narrower section that does not allow the passage of the head of the bolts (4), and through which are inserted the fixing bolts (4), said head of the bolts (4) being arranged in correspondence with the narrowest sections of the slots when the radial blades (3) are in the active working position, in which case the head of such bolts (4) presses against the free face of the radial blades (3) in areas adjacent to the narrowest sections of the through-slots (6).

This application is a Continuation of U.S. application Ser. No. PCT/ES2010/070817, filed Dec. 10, 2010, which is hereby incorporated by reference in its entirety.

### OBJECT OF THE INVENTION

The present invention, as expressed in the statement of this specification, relates to a cutting device for sugar cane harvester intended to carry out the cut of the sugar cane during harvesting by means of radial blades included in support discs that are part of the device of the invention.

Thus, the objective of the invention are characteristic fixing means that associate the radial blades with each support disc, so that such means allow carrying out a quick change of the radial blades when they wear out to achieve better use of the edge of such blades.

### BACKGROUND OF THE INVENTION

Currently, sugar harvesters have discs, wherein are mounted blades that are responsible for cutting the sugar canes.

These blades are screwed to the discs, most commonly using two or three bolts per blade.

The problem with this system is that when you want to change the blade, it is required to completely loosen the bolts with the loss of time that implies, and if the change is made at night it must be added to this problem that the difficulty in the implementation of said change increases, as well as the risk of losing some bolts.

On the other hand, the blades, in order to make the most of the effective length thereof, have two or more sets of holes mounted, in such a way that the blade can be hooked when it is new, as close as possible to the center of the disc, and when it wears out the blade is released and tied at the periphery of the disc.

Likewise, once the blade has been used in both sets of holes it is turned and tied again to use the other cutting profile of the blade which is still unused.

### DESCRIPTION OF THE INVENTION

With the purpose of achieving the objectives and avoiding the drawbacks referred to in the preceding paragraphs, the invention proposes a cutting device for sugar cane harvester determined from support discs, on which are coupled radial blades fixed on the support discs by fixing means elements, such as bolts, so that a part of the blades sticks out the periphery of such support discs, that part being the one carrying out the cut of the sugar cane.

Specifically, the present invention relates to a cutting device for sugar cane harvester which comprising support discs, on which are fixed radial blades by means of fixing bolts, characterized in that the radial blades comprise through-slots through which the fixing bolts are introduced, said through-slots comprise one larger central section that allows the passage of the head of the fixing bolts and at least one narrower end section that does not allow the passage of the head of the fixing bolts, such head of the fixing bolts being arranged in correspondence with the narrowest end sections of the through-slots when the radial blades are in an active working position, in which case the head of such fixing bolts presses against the free face of the radial blades in areas adjacent to the narrowest sections of the through-slots. The present invention is also characterized in that it comprises means of longitudinal retention of said radial blades with respect to the support discs.

On this premise, the cutting device incorporates characteristic means that associate the radial blades with each support disc, said means allowing a quick change of the radial blades when they wear out, achieving a better use of the edge of the radial blades.

Those fixing means are determined from through-slots included in the radial blades comprising a central larger section and two narrower end sections, so that the head of the fixation elements passes through the central section of the slots of the radial blades.

It should be noted that these slots could have another shape, provided that such slots have the wider section that makes the passage of the head of the bolt possible and at least one narrower section where the passage of the head of the fixing bolts is not possible.

The fixation elements are coupled in front holes established on the support discs.

This described structure allows moving, assembling and disassembling the radial blades, without separating the fixation elements of the support disc, achieving these operations by simply loosening the aforementioned fixation elements.

Thus, when fixation elements become loose, the blades can be assembled and disassembled by making the head of the fixation elements match the central section of the slots, being able to move the radial blades until placing them on one of the end sections of the slots, to finally proceed to tighten the fixation elements to immobilize the blades in the desired working position through the heads of such fixation elements that will press against the free face of the radial blades.

Thanks to the end sections of the slots the sets of holes of the discs where the fixation elements are bolted are best used, achieving a more effective use of the cutting edges of the radial blades. Therefore, thanks to the aforementioned end sections, the blade can move in a similar way to a cutter on the disc.

On the other hand, it should be also noted that, due to the geometry of the slots, where the radial blades are mounted in their forward position, the longitudinal displacement of the blade on the support disc can occur punctually due to that the force of friction obtained by the pre-tension of the fixation elements is not enough to withstand the forces generated.

A way of solving said problem is by making a recess arranged in correspondence with the end sections of the slots, in such a way that an interference area as a stop is created that prevents said longitudinal displacement with respect to the support disc. In this situation the head of the fixation elements shall butt against that aforementioned interference area.

Said recess may have different shapes depending on the fixation elements used.

The cutting device of the invention can incorporate an optional fastening means of the radial blades with respect to the support disc, in order to avoid the longitudinal displacement of such blades with respect to the support disc, said means basically consisting of a radial lug where the respective blade butts in its active position through a part of its through-slots.

Next, in order to provide a better understanding of this specification, and being an integral part thereof, a series of figures in which the object of the invention has been represented with an illustrative and not limitative manner are attached.

### BRIEF DESCRIPTION OF THE DRAWINGS

FIG. 1.—It shows a plant view of the cutting device for sugar cane harvester, object of the invention. It basically comprises support discs on each of which several radial blades are fixed.

FIG. 2.—It shows another plant view of the device of the invention.

FIG. 3.—It shows a plant view of one of the radial blades.

FIG. 4.—It represents a perspective view showing in detail the fixation of the radial blades on the support disc.

FIG. 5.—It shows a view similar to the previous one including also a characteristic retention lug of the blades.

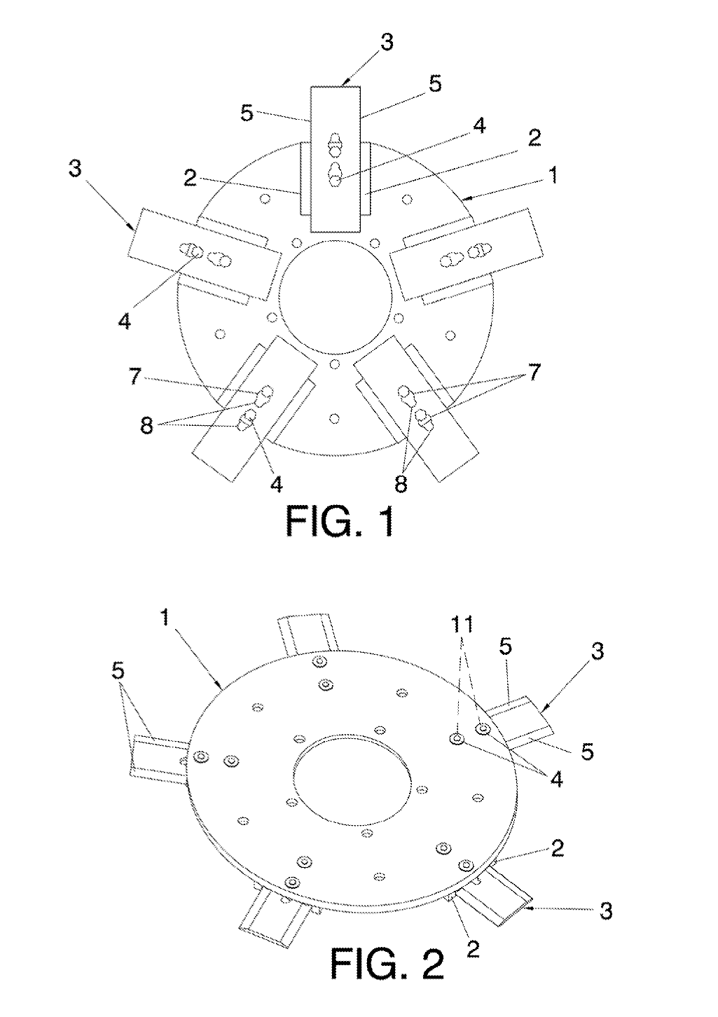

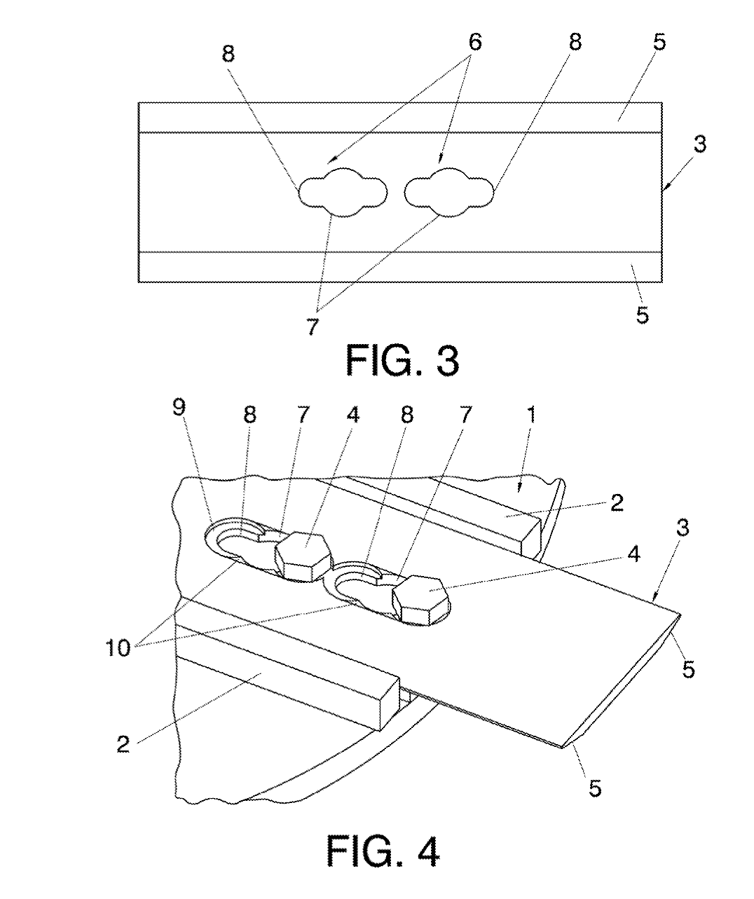

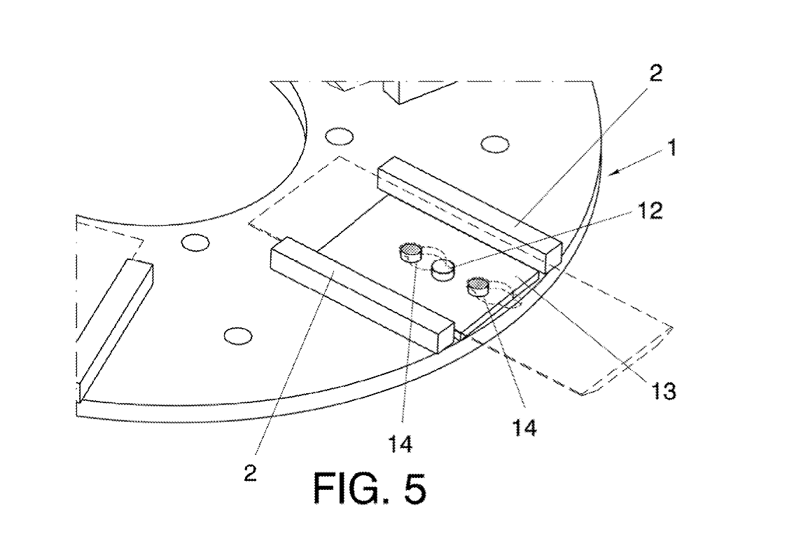

A list of the various elements represented in the figures comprising the invention is provided below:

1. Support discs

2. Pairs of guides

3. Radial blades

4. Fixing bolts

5. Double edge

6. Through-slot

7. Central section

8. End sections

9. Recesses

10. Side stops

11. Threaded holes

12. Retention lug

13. Intermediate plate

### DESCRIPTION OF THE PREFERRED EMBODIMENT

Considering the numbering adopted in the figures, the cutting device for sugar cane harvester comprises support discs 1, each of which includes pairs of guides 2 on which radial blades 3 are arranged that are immobilized on the support discs 1 through fixing bolts 4 coupled in threaded holes 11 established in nuts encastered in the support discs 1. The aforementioned threaded holes could also be incorporated directly in the support discs 1.

A part of the cutting blades 3, which have a double edge 5, sticks out the periphery of such support discs 1, that part being the one carrying out the cut of the sugar cane during the continued rotation of the support discs 1 incorporated in the cutting device of the harvester.

The radial blades 3 incorporate pairs of through-slots 6 through which the fixing bolts 4 are introduced to immobilize the radial blades 3 on the support discs 1 through the heads of such fixing bolts 4.

Each through-slot 6 comprises one larger central section 7 and two narrower end sections 8, and the fixing bolts 4 will be arranged in correspondence with one of them to immobilize the blades 3; the heads of the bolts 4 will sit on recesses 9 arranged on the free faces of the radial blades 3 in correspondence with the end sections 8 of the through-slots 6.

Said recesses 9 give rise in turn to side stops 10 adjacent to the centered sections 7 of the through-slots 6, so that the heads of the fixing bolts 4 make contact on such side stops 10 to prevent the displacement of the radial blades 3 during the working active operation.

With this arrangement described above, a quick change of blades is possible while at the same time a better use of the edges 5 of the radial blades 3 is achieved, obtaining also a total immobilization of such radial blades 3.

The cutting device of the invention can include an optional fastening means of the radial blades 3 with respect to the support disc 1, in order to prevent the longitudinal displacement of such radial blades 3 with respect to the support disc 1.

Said fastening means comprises a retention lug 12 where the end section 8 which is free butts, i.e. wherein there is no respective fixing bolt 4, thus preventing the longitudinal displacement of the respective radial blade 3 in both directions with respect to the support disc 1.

The retention lug 12 is preferably integral to an intermediate plate 13 that is sandwiched in the seat of the radial blades 3, while at the same time such intermediate plate 13 includes holes 14 faced with the threaded holes 11 where the fixing bolts 4 are coupled. The retention lug 12 could also be integral to the support disc 1 without having to use the intermediate plate 13.

1-9. (canceled)

10. Cutting device for sugar cane harvester, which comprising support discs (1), on which radial blades (3) are fixed through fixing bolts (4), is characterized in that
the radial blades (3) comprise through-slots (6) through which are introduced the fixing bolts (4), said through-slots (6) comprising one larger central section (7) which allows the passage of the head of the fixing bolts (4) and at least one narrower end section (8) that does not allow the passage of the head of the fixing bolts (4), such head of the fixing bolts (4) being arranged in correspondence with the narrowest end sections (8) of the through-slots (6) during a working active position of the radial blades (3), in which case the head of such bolts (4) presses against the free face of the radial blades (3) in areas adjacent to the narrowest sections of the through-slots (6),
it comprises means of longitudinal retention of said radial blades with respect to the support discs (1).

11. Cutting device for sugar cane harvester, according to claim 10, characterized in that the means of longitudinal retention of the radial blades (3) comprise side stops (10) arranged in correspondence with the free face of the support discs (1) in areas adjacent to the narrowest end sections (8) of the through-slots (6), and the head of the fixing bolts (4) makes contact with the stops.

12. Cutting device for sugar cane harvester, according to claim 11, characterized in that the heads of the fixing bolts (4) sit on recesses (9) established on the faces of the radial blades (3) that are in correspondence with the free face of the support disc (1), such recesses (9) generate the side stops (10).

13. Cutting device for sugar cane harvester, according to claim 10, characterized in that the through-slots (6) comprise one larger central section (7) and two narrower end sections (8) and the fixing bolts (4) are arranged in correspondence with one of them in the working active position.

14. Cutting device for sugar cane harvester, according to claim 10, characterized in that it includes an additional fastening means of the radial blades (3) consisting of a retention lug (12) where a part of the through-slots (6) of the aforementioned radial blades (3) butts in its active position.

15. Cutting device for sugar cane harvester, according to claim 13, characterized in that the free end section (8) of the through-slots (6) butts against the retention lug (12), while the other end section (8) butts against the respective fixing bolt (4).

16. Cutting device for sugar cane harvester, according to claim 14, characterized in that the retention lug (12) is integral to an intermediate plate (13) that is sandwiched in the seat of the radial blades (3).

17. Cutting device for sugar cane harvester, according to claim 14, characterized in that the retention lug (12) is integral to the support disc (1).

18. Cutting device for sugar cane harvester, according to claim 11, characterized in that it includes an additional fastening means of the radial blades (3) consisting of a retention lug (12) where a part of the through-slots (6) of the aforementioned radial blades (3) butts in its active position.

19. Cutting device for sugar cane harvester, according to claim 12, characterized in that it includes an additional fastening means of the radial blades (3) consisting of a retention lug (12) where a part of the through-slots (6) of the aforementioned radial blades (3) butts in its active position.

20. Cutting device for sugar cane harvester, according to claim 13, characterized in that it includes an additional fastening means of the radial blades (3) consisting of a retention lug (12) where a part of the through-slots (6) of the aforementioned radial blades (3) butts in its active position.

21. Cutting device for sugar cane harvester, according to claim 14, characterized in that the free end section (8) of the through-slots (6) butts against the retention lug (12), while the other end section (8) butts against the respective fixing bolt (4).

22. Cutting device for sugar cane harvester, according to claim 15, characterized in that the retention lug (12) is integral to an intermediate plate (13) that is sandwiched in the seat of the radial blades (3).

23. Cutting device for sugar cane harvester, according to claim 15, characterized in that the retention lug (12) is integral to the support disc (1).
